(19) United States
(12) Patent Application Publication
(10) Pub. No.: US 2025/0021800 A1
(43) Pub. Date: Jan. 16, 2025

(54) MEMORY EFFICIENT SEQUENCE GENERATION NEURAL NETWORKS

(71) Applicant: Google LLC, Mountain View, CA (US)

(72) Inventor: Yuanzhong Xu, Mountain View, CA (US)

(21) Appl. No.: 18/222,327

(22) Filed: Jul. 14, 2023

(51) Int. Cl. G06N 3/0455

(52) U.S. Cl. CPC G06N 3/0455

(57) ABSTRACT

Methods, systems, and apparatus, including computer programs encoded on computer storage media, for generating multiple output sequences in parallel from an input sequence by using an auto-regressive generative neural network. The auto-regressive generative neural network can include one or more attention layers. Each attention layer is configured to update the embedded representations of the output tokens at the respective output positions in each output sequence by applying an attention mechanism.

### BACKGROUND

This specification relates to transducing sequences using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes a system implemented as computer programs on one or more computers in one or more locations that generates multiple output sequences from an input sequence, i.e., transduces one input sequence into two or more output sequences. The input sequence includes a respective input at each of multiple positions in an input order. Each output sequence includes a respective output at each of multiple positions in an output order. In particular, the system generates the output sequences using an auto-regressive generative neural network that is self-attention-based.

Particular embodiments of the subject matter described in this specification can be implemented so as to realize one or more of the following advantages. The neural network system described in this specification can use an auto-regressive generative neural network to generate multiple output sequences from an input sequence in parallel to reduce processing times, while having a reduced memory footprint relative to some existing neural network systems that similarly make use of such a neural network. The neural network system reduces the amount of storage space by not storing multiple copies of the same data, which includes embedded representations of the input tokens included in the input sequence, as is required by these existing systems. Instead, the neural network system stores only one copy of the embedded representations of the input tokens for each attention layer, and broadcasts this copy in-place and on-demand within each attention layer when computing an output of the attention layer. This alleviates the memory burden that some existing systems impose when generating multiple output sequences in parallel because storing multiple copies (i.e., one copy for each of the multiple output sequences) of the embedded representations of the input tokens is no longer needed. When the input sequence is long, e.g., includes 2000, 4000, or more input tokens, storing multiple copies of the embedded representations of the input tokens for each attention layer in an attention neural network that includes multiple attention layers consumes a significant amount of memory resources. Therefore the neural network system as described in this specification enables more efficient use of memory resources than these existing systems.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example neural network system.

FIGS. 2A-B are example illustrations of data stored in a memory device when applying multiple attention mechanisms in parallel.

FIG. 3 is a flow diagram of an example process for updating embedded representations of output tokens in multiple output sequences.

FIG. 4 is an example illustration of operations performed by an attention layer when applying multiple attention mechanisms in parallel.

FIG. 5 is another example illustration of operations performed by an attention layer when applying multiple attention mechanisms in parallel.

Like reference numbers and designations in the various drawings indicate like elements.

### DETAILED DESCRIPTION

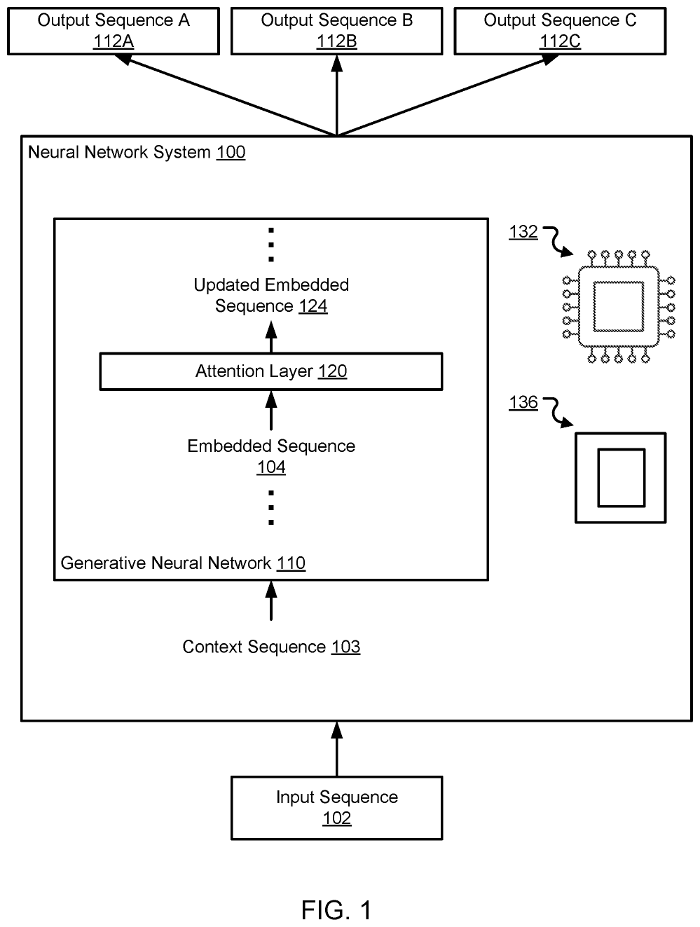

FIG. 1 is a diagram of an example neural network system 100. The neural network system 100 is an example of a system implemented as computer programs on one or more computers in one or more locations, in which the systems, components, and techniques described below can be implemented.

The neural network system 100 can be implemented on a mobile computing device, e.g., a smart phone, a smart watch or another wearable computing device, a tablet computer, or a laptop computer, or can alternatively be hosted within a data center, e.g., a distributed, cloud-based computing system, that has one or more computing devices 132 and one or more memory devices 136, e.g., in one or more locations. In general, each computing device 132 can include a processing unit, such as a processor, multiple processors, or multiple processor cores, that can access the data stored in the one or more memory devices 136 and execute operations of the components of the neural network system 100, e.g., layer operations of the generative neural network 110. For example, the one or more computing devices 132 can include hardware accelerates, e.g., graphics processing units (“GPUs”), field-programmable gate arrays (“FGPAs”), and application-specific integrated circuits (“ASICs”), including tensor processing units (“TPUs”).

The one or more memory devices 136 stores the data, e.g., the data processed by the hidden layers of the generative neural network 110, that is required for execution of the operations of the components of the neural network system 100. The memory devices 136 may either be or include logical memory devices, or may alternatively be or include physical memory devices. In some implementations, the memory devices 136 include a volatile memory unit or units. In some other implementations, the memory devices 136 include a non-volatile memory unit or units. The memory devices 136 may be coupled to the computing device 132 using electrical connections, optical connections, or wireless connections.

In some implementations, the memory devices 136 are part of the computing devices 132. For example, the memory devices 136 can be disposed within the integrated circuit die representing a special-purpose hardware circuit, such that the memory devices 136 are local to or co-located with computing resources of the circuit.

Alternatively, in other implementations, memory devices 136 are an external or off-chip memory relative to a hardware circuit that includes one or more processors or processor cores. For example, the memory devices 136 can be disposed at a physical location that is outside of an integrated circuit die that represents a hardware circuit of the computing device 132. Hence, the memory devices 136 can be distant or non-local relative to computing resources disposed within the integrated circuit die.

The neural network system 100 is a system that generates multiple output sequences A-C 112A-C from an input sequence 102 in response to one or more received requests. The input sequence 102 includes a respective input at each of multiple input positions in an input order. Each output sequence, e.g., output sequence A 112A, includes a respective output at each of multiple output positions in an output order. The output sequences A-C 112A-C can have different lengths from one another, i.e., can include different numbers of output positions.

Although a total of three output sequences are illustrated in the example of FIG. 1, it will be appreciated that in other examples, the neural network system 100 can generate more or fewer output sequences from the input sequence 102, each output sequence having more or fewer output positions.

For example, the neural network system 100 can be a text generation system that generates text sequences, i.e., each output sequence generated by the system 100 is a sequence of text tokens from a vocabulary of text tokens that includes, e.g., one or more of characters, sub-words, words, punctuation marks, numbers, or other symbols that appear in natural language text. For example, the system 100 can generate text sequences conditioned on the input sequence in response to received requests and provide at least one of the text sequences for presentation to users.

As another example, the neural network system 100 can be an image generation system that generates images as sequences of pixels, i.e., each output sequence generated by the system 100 is a sequence of values representing pixels or patches in an output image arranged according to a specified order.

As yet another example, the neural network system 100 can be a multi-modal system that processes, e.g., both text and image input sequences, or both text and audio input sequences, and generates the output sequences that are either in a single data modality or in multiple data modalities. Examples of such multi-modal systems include an open-vocabulary image classification system, an open-vocabulary object detection system, an image captioning system, a text-based image search system, an image-based retrieval system, and so on.

As a particular example, the neural network system 100 can be part of a chat bot system and the input sequence can include audio or text from the most recent conversational turn submitted by a user of the chat bot system during the dialog while the output sequences are the next turn in the conversation, e.g., either text or audio that is a response to the most recent conversational turn. Optionally, the input sequence 102 can also include one or more historical conversational turns that occurred earlier in the conversation.

As another particular example, the neural network system 100 can be part of a machine translation system and the input sequence can include text in a source language while the output sequences each include text in a target language that is a translation of the source text into the target language.

As another particular example, the neural network system 100 can be part of a natural language processing system. For example, if the input sequence is a sequence of words in an original language, e.g., a sentence or phrase, the target sequence may be a summary of the input sequence in the original language, i.e., a sequence that has fewer words than the input sequence but that retains the essential meaning of the input sequence. As another example, if the input sequence is a sequence of words that form a question, the output sequences can each be a sequence of words that form an answer to the question.

As another example, the neural network system 100 can be part of a computer-assisted medical diagnosis system. For example, the input sequence can be a sequence of data from an electronic medical record and the output sequences can each be a sequence of predicted treatments.

As another particular example, the neural network system 100 can be part of a computer code generation system and the input sequence can be a text description of a desired piece of code or a snippet of computer code in a programming language and the output sequences can each include computer code, e.g., a snippet of code that is described by the input sequence or a snippet of code that follows the input sequence 102 in a computer program.

In these examples, while the requests are typically submitted by one or more users, e.g., through a client device that is in data communication with the neural network system 100, the input sequence 102 may be obtained by the system 100 in any of a variety of ways.

In some cases, the input sequence 102 is generated by the neural network system 100 from data received from the same user that submitted the request. For example, when prompt text is received as part of the request, the neural network system 100 can apply a tokenization process to the prompt text to generate the input sequence 102, and then generate, from the input sequence 102, the output sequences A-C 112A-C that are each a response to the prompt text.

In some of these cases, the prompt text could be or include a k-shot prompt provided by the user, where k generally corresponds to the number of examples of input output pairs. Each example can be in the form of an input followed by a desired output that should be generated by the generative neural network 110 based on processing the input. Some common patterns for prompting include one-shot prompt (where k=1) and few-shot prompts (where k>=2).

In some other cases, the input sequence 102 is a predetermined sequence that is stored at a memory device, e.g., one of the memory devices 136, accessible by the system. For example, the predetermined sequence may include tokens generated from a predetermined prompt that represents general guideline information about how the neural network system 100 should generate the output sequences A-C 112A-C. The predetermined prompt could, e.g., give examples of input output pairs, impose constraints on the output generated by the generative neural network 110, or both. For example, such predetermined prompt could be defined by a system administrator at the deployment time of the neural network system 100, with respect to what should or should not be included in the output sequences A-C 112A-C. In these cases, the same input sequence 102 may be shared among multiple output sequences that are generated in response to different requests.

In yet other cases, the input sequence 102 is a combination of both user-specified prompt text and the predetermined prompt, e.g., can be a combined input sequence generated by the system 100 by concatenating prompt text tokens to predetermined tokens (or the other way around).

In any of these cases, the input sequence 102 may be a very long input sequence, e.g., may be a text sequence that includes 2000, 4000, or more text tokens selected from the vocabulary of text tokens.

At a high level, the neural network system 100 receives a request and, in response, generates multiple output sequences A-C 112A-C using an auto-regressive generative neural network 110 and conditioned on the input sequence 102. In particular, instead of generating only a single output sequence, the system 100 generates two or more output sequences in response to each request.

The system can generate multiple candidate output sequences in response to a single input sequence for a variety of purposes.

In some cases, the system can generate multiple outputs because the received request explicitly or implicitly requires that a number of different output sequences should be generated from the same input sequence 102. For example, the user may explicitly require, e.g., by way of a selection button, that the system provides two or more candidates output sequences in response to an input sequence, e.g., to show different examples of plausible outputs for the same prompt. In some other cases, this could be because the system 100 is configured to leverage the auto-regressive nature of the generative neural network 110 to generate multiple different candidate output sequences 112A-C in response to the same request, such that the system can then determine, e.g., in accordance with a set of one or more criteria, which of the multiple sequences 112A-C to provide as the final (e.g., the most suitable) output sequence in response to the request. Alternatively, the system can present all of the multiple sequences 112A-C as candidate outputs to the user.

Each output sequence 112A-C includes a respective output token from the vocabulary of tokens at each of multiple output positions. The vocabulary of tokens can include any of a variety of tokens that represent text symbols or other symbols. For example, the vocabulary of tokens can include one or more of characters, sub-words, words, punctuation marks, numbers, or other symbols that appear in a corpus of text. For example, the text can be natural language text or computer code.

The generative neural network 110 is referred to as an auto-regressive generative neural network because the generative neural network 110 auto-regressively generates an output sequence of tokens by generating each particular output token in the output sequence conditioned on a current context sequence 103 that includes (i) the input tokens included in the input sequence 102 and (ii) any output tokens that precede the particular output token in the output sequence, i.e., the output tokens that have for already been generated for any previous positions in the output sequence that precede the particular position of the particular output token.

In particular, at each generation time step, the neural network system 100 generates, as the current context sequence 103, a combined sequence for the generation time step. The combined sequence includes the input tokens included in the input sequence 102 followed by the output tokens in an output sequence, e.g., output sequence A 112A, that have already been generated as of the generation time step, i.e., the output tokens at preceding output positions in the output order. In this way, the current context sequence 103 jointly represents the input sequence 102 and the already generated output as a single combined sequence (although in some cases the combined sequence may exceed a maximum allowed length and the system drops some of the tokens either in the input sequence 102 or in the current context sequence 103). At each generation time step, the neural network system 100 is configured to update the context sequence 103 to include the output token that has been generated in the immediately preceding generation time step, e.g., by taking the latest generated output token and appending it to the end of the current context sequence.

For example, the current context sequence 103 when generating an output token at any given output position in the output sequence can include all of the input tokens included in the input sequence 102, followed by the output tokens at any preceding positions that precede the given output position in the output sequence. Optionally, within the current context sequence 103, the input tokens and the output tokens are separated by one or more predetermined separator tokens.

To generate a particular output token at a particular output position within an output sequence, the generative neural network 110 can process the current context sequence 103 to generate a score distribution, e.g., a probability distribution, that assigns a respective score, e.g., a respective probability, to each token in the vocabulary of tokens. The generative neural network 110 can then select, as the particular output token, a token from the vocabulary using the score distribution. For example, the generative neural network 110 can sample, e.g., using beam search decoding, Sample-and-Rank decoding, top-K sampling, nucleus sampling, or another suitable sampling technique, a token from the distribution.

As a particular example, the generative neural network 110 can be an auto-regressive Transformer-based neural network that includes (i) a plurality of attention layers that each apply a self-attention operation and (ii) an output subnetwork that processes an output of the last attention layer to generate the score distribution.

The generative neural network 110 can have any of a variety of Transformer-based neural network architectures. Examples of such architectures include those described in Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020; Tom B Brown, Benjamin Mann, Nick Ryder, Melanie Subbiah, Jared Kaplan, Prafulla Dhariwal, Arvind Neelakantan, Pranav Shyam, Girish Sastry, Amanda Askell, et al. Language models are few-shot learners. arXiv preprint arXiv:2005.14165, 2020; and Aakanksha Chowdhery, et al. Palm: Scaling language modeling with pathways. arXiv preprint arXiv:2204.02311 (2022).

Generally, the Transformer-based neural network includes a sequence of attention layers, and, during the processing of a given input sequence, each attention layer in the sequence receives a respective embedded representation for each token in the current context sequence 103 and an embedded representation for an output token to be generated, i.e., the new output token to be appended to the current context sequence 103. The attention layer then updates the embedded representation for the new output token to be generated at least in part by applying self-attention to generate an updated embedded representation for the token to be generated. The embedded representations for the first attention layer are embedded representations which have been generated by an embedding layer, and the embedded representations for each subsequent attention layer are the updated embedded representations generated by the preceding layer, e.g., a preceding attention layer or a different type of neural network layer that is arranged preceding to the attention layer.

An “embedded representation,” as used in this specification is a vector of numeric values, e.g., floating point or other type of numeric values, that has a predetermined dimensionality, e.g., has a predetermined number of values.

As shown in FIG. 1, the generative neural network 110 includes an attention layer 120. The attention layer 120 operates on an embedded sequence 104 and generates a corresponding updated embedded sequence 124. Although one attention layer is depicted in FIG. 1 for convenience, as described above, the generative neural network 110 generally includes many other layers, including other attention layers and, for example, an embedding layer and an output layer.

The embedded sequence 104 includes a respective embedded representation for each token in the current context sequence 103 and an embedded representation for the token to be generated. That is, at each generation time step, the embedded sequence 104 includes (i) an embedded representation for each input token included in the input sequence 102, (ii) an embedded representation for each output token in an output sequence that has already been generated as of the generation time step, as well as (iii) an embedded representation for the new output token to be appended to the output sequence.

To generate the updated embedded sequence 124 from the embedded sequence 104, the attention layer 120 receives the embedded sequence 104 for the attention layer 120 and applies an attention mechanism on the embedded sequence 104 to generate an updated embedded sequence 124. For example, the attention mechanism can be a self-attention mechanism, e.g., a masked self-attention mechanism. Masked self-attention mechanism is described in more details in Peter J. Liu, et al. “Generating wikipedia by summarizing long sequences.” arXiv preprint arXiv:1801.10198 (2018), respectively, which is incorporated by reference herein in its entirety.

In some implementations, the attention layer 120 can apply additional operations to the updated embedded sequence 124 that is provided as output to the next component of the network 110. For example, a fully-connected neural network then operates on the updated embedded sequence 124 to generate a transformed updated embedded sequence, e.g., by processing each attended embedded representation through the fully-connected neural network and then, optionally, applying layer normalization, a residual connection, or both to the output of the fully-connected neural network. In some other implementations, the updated embedded sequence 124 can be provided to a subsequent layer included in the neural network, which can for example be another attention layer or an output layer.

Because the generative neural network 110 is auto-regressive, the system 100 can use the same neural network 110 to generate multiple different output sequences A-C 112A-C in response to the same request. For example, the system can do so by using a output token sampling strategy, e.g., by using beam search decoding from score distributions generated by the generative neural network 110, using a Sample-and-Rank decoding strategy, or using another decoding strategy that leverages the auto-regressive nature of the neural network. As another example, the system can do so by using a different random seed for the pseudorandom number generator together with a suitable output token sampling strategy, e.g., a top-K sampling or a nucleus sampling strategy, to introduce randomness in the sampling of the output token.

To reduce the time required for generating these output sequences, the generation of the multiple output sequences A-C 112A-C by the generative neural network 110 will typically be parallelized. When generating multiple output sequences in parallel, at each generation time step, the generative neural network 110 independently selects, from the vocabulary, a different token for each of the multiple output sequences A-C 112A-C.

In particular, at each generation time step, for each of the multiple output sequences A-C 112A-C, the attention layer 120 receives a corresponding embedded sequence 104 that includes an embedded representation for each token in a corresponding current context sequence 103. For the multiple output sequences, their current context sequences may differ from each other in at least some of the already generated output tokens. The attention layer 120 then updates the multiple embedded sequences, which correspond respectively to the multiple output sequences A-C 112A-C, in parallel with each other to generate the multiple updated embedded sequences. In particular, the attention layer 120 updates the embedded sequences at least in part by applying self-attention mechanisms independently of each other, such that the multiple embedded sequences generated from the corresponding current context sequences can be updated concurrently.

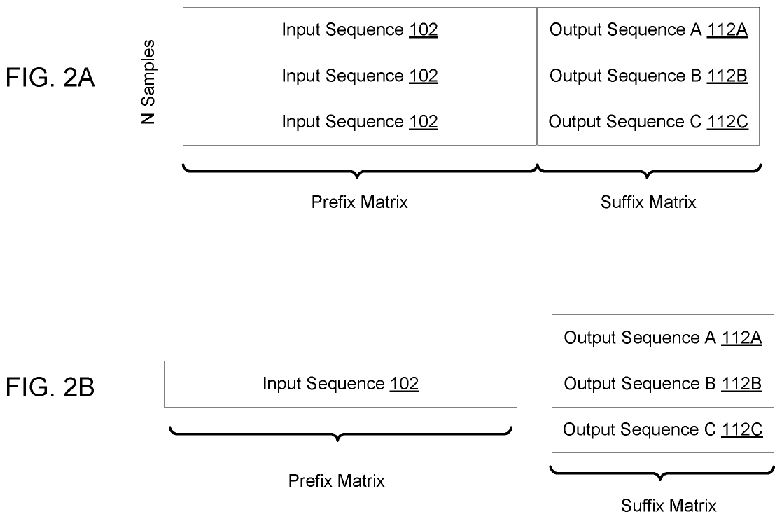

FIGS. 2A-B are example illustrations of data stored in a memory device when applying multiple attention mechanisms in parallel. For example, the memory device can be one of the memory devices 136 shown in FIG. 1.

A common approach to facilitate parallelized generation of multiple output sequences (due to its ease of implementation using existing matrix/tensor operations available in machine learning libraries) is to store multiple copies of the input sequence in the memory device, and then append a different output sequence to each copy of the input sequence.

As shown in FIG. 2A, to generate the three output sequences A-C 112A-C in parallel, this common approach involves storing a total of three copies of the input sequence 102 in the memory device, each followed by the already generated portion of one of the different output sequences A-C 112A-C. The three copies of the input sequence 102 can be stored in the form of a prefix matrix. The prefix matrix has three (identical) rows, where each row includes the respective embedded representation of each of the plurality of input tokens included in the input sequence 102.

Likewise, the already generated portions of the different output sequences A-C 112A-C can be stored in the form of a suffix matrix. The suffix matrix has three rows, where each row includes the respective embedded representation of each of the plurality of output tokens that have already been generated for the corresponding output sequence. For example, the first row of the suffix matrix includes embedded representations of the output tokens that have already been generated for output sequence A 112A, the second row of the suffix matrix includes embedded representations of the output tokens that have already been generated for output sequence B 112B, and so on. Unlike the prefix matrix where all rows are identical, the rows in the suffix matrix will generally be different from each other.

When concatenated along a row dimension, the prefix matrix and the suffix matrix will collectively represent the embedded representations for the tokens in the multiple current context sequences that correspond respectively to the multiple output sequences. The one or more computing devices 132 of the neural network system 100 can then execute the operations the attention layer 120 of the generative neural network 110 on the concatenated prefix and suffix matrices to achieve parallel processing of the different current context sequences to generate multiple output sequences concurrently.

One problem with this approach shown in FIG. 2A, however, is that the storage of multiple copies of the input sequence 102 during the generation of the output sequences 112A-C consumes a significant amount of memory resources, and is thus, also inefficient in terms of memory usage. This can be especially problematic when the input sequence 102 is a long input sequence, e.g., an input sequence that include 2000, 4000, or more tokens, since storing multiple identical copies of such a long input sequence takes significant space in the memory device.

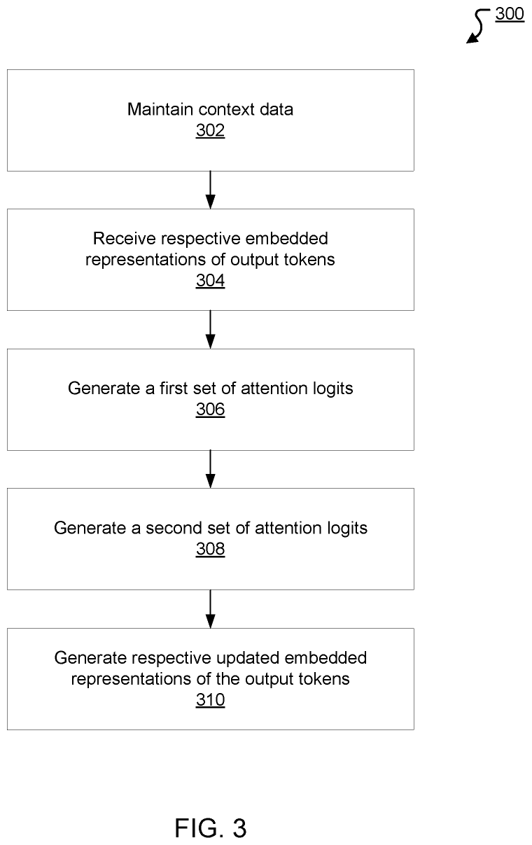

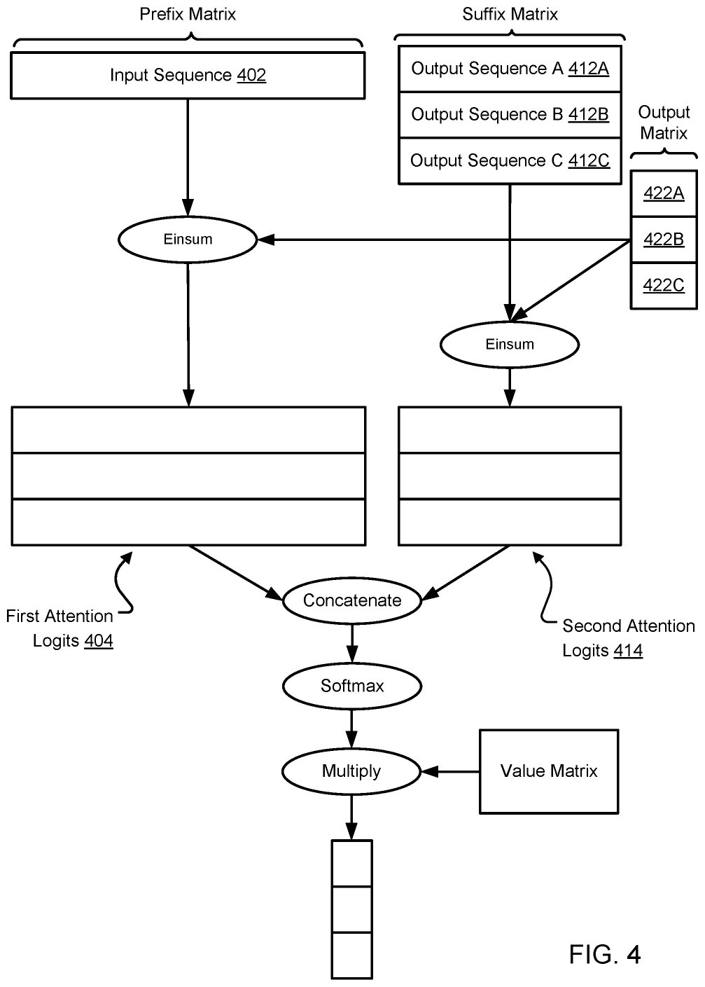

In contrast, as shown in FIG. 2B, by using the prefix broadcast techniques that will be described further below with reference to FIGS. 3 and 4, only one copy of the input sequence 102 needs to be stored in the memory device. This copy of the input sequence 102 is then broadcasted in-place and on-demand within each attention layer to facilitate parallelized generation of multiple output sequences. Accordingly, the neural network system 100 can increase memory performance during the parallelized generation of multiple output sequences by not storing multiple copies of the same data. The improvement in memory performance can be significant in the cases where the input sequence 102 is long.

FIG. 3 is a flow diagram of an example process 300 for updating embedded representations of output tokens in multiple output sequences. For convenience, the process 300 will be described as being performed by a system of one or more computers located in one or more locations. For example, a neural network system, e.g., the neural network system 100 depicted in FIG. 1, appropriately programmed in accordance with this specification, can perform the process 300.

In general, the system can perform the process 300 as part of generating multiple output sequences from an input sequence by using an auto-regressive generative neural network, e.g., in response to receiving a request for the multiple output sequences. The input sequence includes a respective input token at each of multiple input positions. Each output sequence includes a respective output token at each of multiple output positions.

When the auto-regressive generative neural network is a Transformer-based neural network that includes a sequence of attention layers, the system can, for each particular output position of the multiple output positions of each output sequence, repeatedly perform the process 300 at each attention layer in the sequence to generate a new output token for each of the output sequences.

More specifically, the system can perform the process 300 at each of multiple generation time steps to generate the multiple output sequences using the generative neural network. The generative neural network is configured to generate the output sequences in parallel from the input sequence in an auto-regressive manner. That is, at each generation time step and for the multiple output sequences, the generative neural network generates one output token for each of the multiple output sequences in parallel. Thus, by performing the process 300 at each of the multiple generation time steps, the system generates all of the output tokens in each of the multiple output sequences. For convenience, the location of the output token that is being generated at each generation time step within each output sequence will be referred to as the “particular output position” of the output sequence.

The system maintains context data (step 302). The context data includes a respective embedded representation of each of the multiple input tokens included in the input sequence. The context data also includes, for each output sequence, a respective embedded representation of an output token at each output position that precedes the particular output position of the output sequence, i.e., a respective embedded representation of each output token that has already been generated as of the generation time step. As described above, the embedded representations for the first attention layer are embedded representations which have been generated by an embedding layer, and the embedded representations for each subsequent attention layer are the updated embedded representations generated by the preceding layer, e.g., a preceding attention layer or a different type of neural network layer.

FIG. 4 is an example illustration of operations performed by an attention layer when applying multiple attention mechanisms in parallel. As illustrated, the context data can be stored in the form of a prefix matrix and a suffix matrix in a memory device accessible by the system. The prefix matrix has numeric values that represent the respective embedded representation of each of the multiple input tokens included in the input sequence 402. The suffix matrix has numeric values that represent, for each of the multiple output sequences A-C 412A-C, the respective embedded representation of the output token at each output position that precedes the particular output position.

For each output sequence, the system receives, at the attention layer, a respective embedded representation of the output token at the particular output position within the output sequence (step 304). The embedded representation can be similarly received by the attention layer in the form of an output matrix. The output matrix has rows that correspond to multiple output sequences. Thus, as illustrated in FIG. 4, the output matrix has three rows. Each row corresponds to one of the multiple output sequences and includes numeric value(s) that represent the embedded representation of the output token, i.e., output token 422A, 422B, or 422C, at the particular output position within the output sequence. For the first attention layer in the sequence of attention layers, the embedded representation can be generated by the system from the previous output token(s) of the generative neural network; for each subsequent attention layer in the sequence of attention layers, the embedded representation can be the updated embedded representation generated by the preceding layer, e.g., a preceding attention layer or a different type of neural network layer.

Specifically, at each generation time step, because the generative neural network is configured to auto-regressively generate an output sequence from the input sequence, the embedded representation of the output token at the particular output position to be provided to the first attention layer can be, or include, an embedded representation which has been generated by an embedding layer of the generative neural network from processing the output tokens generated at one or more preceding generation time steps.

For the very first generation time step, because there is no previously generated output token, the system can provide one or more tokens included in the input sequence, e.g., a last token of the input sequence, as the input tokens, and then process the input tokens by using the embedding layer of the generative neural network to generate the embedded representation of the output token at the particular output position to be provided to the first attention layer.

The system generates a first set of attention logits that includes multiple logit values for each of the multiple input tokens included in the input sequence (step 306). The system can do so based on applying a first attention mechanism over the respective embedded representation of each of the plurality of input tokens included in the input sequence.

To apply the first attention mechanism, the attention layer uses one or more attention heads. Each attention head generates a query Q vector, a key K vector, and a value V vector for the embedded representation of the output token at the particular output position within the output sequence, e.g., by processing the embedded representation using a query, key, and value linear transformation, respectively. As illustrated in FIG. 4, for each of the multiple output sequences A-C 422A-C, each attention head generates a query Q vector (and, analogously, a key K vector and a value V vector) from the embedded representation of the output token at the particular output position within the output sequence. Thus, each attention head generates three query Q vectors (and, analogously, three key K vectors and three value V vectors) for a total of three output sequences A-C 422A-C. In addition, each attention head generates a query Q vector, a key K vector, and a value V vector for the embedded representation of each input token included in the input sequence, e.g., by processing the embedded representation using the query, key, and value linear transformation, respectively. Each attention head then applies any of a variety of variants of query-key-value (QKV) attention using the query, key, and value vectors to generate an output. For example, the attention can be a self-attention mechanism, e.g., a masked self-attention mechanism, e.g., a full self-attention mechanism, or an approximate self-attention mechanism, e.g., a sparse or linear self-attention mechanism.

For each query Q vector, the attention head generates a respective attention logit 404 for each key K vector that has been generated for the embedded representation of each input token included in the input sequence, as well as for the embedded representation of the output token at the particular output position within each of the multiple output sequences. A “logit” as used in this specification is a numerical value, i.e., a score, assigned to a particular data item.

In particular, for a given query Q vector, the attention head generates the attention logits 404 by applying an attention function between the given query Q vector and the key K vectors. The attention function can be any attention function that can be used as part of query-key-value (QKV) attention, e.g., dot product attention or scaled dot product attention.

One approach to compute this attention function is to generate a query Q matrix representing the query Q vectors and a key K matrix representing the key K vectors, and then compute a matrix multiplication between the query Q matrix and the key K matrix to generate a first matrix product which is then optionally scaled by a scaling factor, e.g., by the square root of the dimensions of the queries and keys. One example approach to do so is by using an “Einsum” operation, which is generalized matrix multiplication operation, available in machine learning libraries.

Specifically, the query Q matrix and the key K matrix can each be generated by each attention head from the prefix matrix and the output matrix, namely by concatenating the prefix matrix to the output matrix, and then multiplying the concatenated matrix with a weight matrix having learned numeric values that represent the query Q (or key K) linear transformation to generate the query Q (or key K) matrix.

In addition to the “Einsum” operation, because the output matrix (which has rows that correspond to multiple output sequences) has more rows than the prefix matrix, e.g., three rows versus one row as in the example of FIG. 4, a “Broadcast” operation available in the machine learning libraries can also be used by each attention head. Broadcasting is the process of making matrices have compatible shapes for arithmetic operations. Two shapes are compatible if for each corresponding dimension pair of their shapes, the dimensions are either equal or one of them is one. When a matrix is broadcasted to a shape, the operation starts with the trailing dimensions and works its way forward. Thus, to generate the attention logits 404 by way of matrix multiplication, the “Broadcast” operation can be executed to return a matrix that is the prefix matrix replicated as many times as need until a specified shape that is compatible with the shape of the output matrix is reached, i.e., to replicate the prefix matrix along a column dimension to match the row number of the output (or suffix) matrix. By performing the broadcast operation in-place on-demand within the attention layer, the attention layer reduces the memory burden because no extra copy of the input sequence needs to be stored in the memory device.

In this specification, “in-place” means the replicated data will not be materialized in the memory. It can be done by either combining the broadcast with the computation via operation fusion, or using an Einsum operation that implicitly handles the broadcast. “On-demand” means that a process or operation is executed only upon being triggered.

The system generates a second set of attention logits that includes, for each output sequence, a logit value for the output token at each output position that precedes the particular output position (step 308). For each of the multiple output sequences, the system can do so based on applying a second attention mechanism over the respective embedded representation of the output token at each output position that precedes the particular output position within the output sequence.

To apply the second attention mechanism, the attention layer uses one or more attention heads. Each attention head generates, for each of the multiple output sequences, a query Q vector, a key K vector, and a value V vector for the embedded representation of each output token included in the output sequence. Each attention head then applies any of a variety of variants of query-key-value (QKV) attention using these query, key, and value vectors, together with the query, key, and value vectors that has been generated from the embedded representation of the output token at the particular output positions within the multiple output sequences (as described above at step 306), to generate an output.

Like how the attention function is computed with respect to the input sequence, here each attention head can similarly compute this attention function by generating a query Q matrix representing the query Q vectors and a key K matrix representing the key K vectors, and then compute a matrix multiplication between the query Q matrix and the key K matrix to generate a second matrix product, e.g., by using an “Einsum” operation available in machine learning libraries, which is then optionally scaled by a scaling factor, e.g., by the square root of the dimensions of the queries and keys. Specifically, the query Q matrix and the key K matrix can each be generated by each attention head from the suffix matrix and the output matrix, namely by concatenating the suffix matrix to the output matrix, and then multiplying the concatenated matrix with a weight matrix having learned numeric values that represent the query Q (or key K) linear transformation to generate the query Q (or key K) matrix. Unlike step 306, however, since the suffix matrix and the output matrix already have compatible shapes, no “Broadcast” operation needs to be performed to generate the second set of attention logits 414.

In particular, unlike in conventional attention logits computation, in which all of the attention logits for each attention head are generated at once, the system generates two sets of attention logits that are separate from each other, with one generated with respect to the input sequence, and the other generated with respect to the multiple output sequences.

The system generates, from the first and second sets of attention logits, an updated embedded representation of the output token at the particular output position of the output sequence (step 310).

As illustrated in FIG. 4, each attention head concatenates the first matrix product (computed at step 306) and the second product (computed at step 308), which represent the first and second sets of attention logits, respectively, along a row dimension. Each attention head processes the concatenated first and second matrix products using a compatibility function, e.g., the softmax function in FIG. 4, to generate a weight matrix, and then multiplies the weight matrix with a value matrix, which includes those value V vectors generated above at steps 306 and 308, to generate a weighted value matrix as output of the attention head. The weighted value matrix includes numeric values as matrix entries that represent the respective updated embedded representations of the output tokens at the particular output positions of the multiple output sequences. When there is a single attention head, the output of the attention head is used as the output of the attention layer. When there are multiple attention heads, the attention layer then combines the outputs of the multiple attention heads, e.g., by concatenating the outputs and, optionally, processing the concatenated outputs through a linear layer.

When the attention layer is not the last layer in the auto-regressive generative neural network, the system can then provide the updated embedded sequence as the input to the subsequent neural network layer in the neural network, which can for example be a feed-forward layer, a layer normalization layer configured to apply layer normalization to the updated embedded sequence, or another attention layer. By repeatedly performing the process 300 for all of the attention layers in the neural network and then by processing at least part of the updated embedded sequence generated by the last attention layer in the neural network using one or more output layer(s), the system can generate the score distribution that can be used to select the token at the particular output position within each of the multiple output sequences.

In practice, because the multiple output sequences may, and generally will, have different lengths from one another, i.e., can include different numbers of output positions, the system can begin with performing the process 300 for all the multiple output sequences, and then switch to performing the process 300 for only some the multiple output sequences (less those that are completed). Specifically, the system stops appending output tokens to already the generated output tokens and, in some implementations, removes the embedded representations associated with an output sequence from the memory, once the output sequence has been finalized, e.g., once an end-of-sequence (EOS) token has been sampled or some other termination criterion has been satisfied.

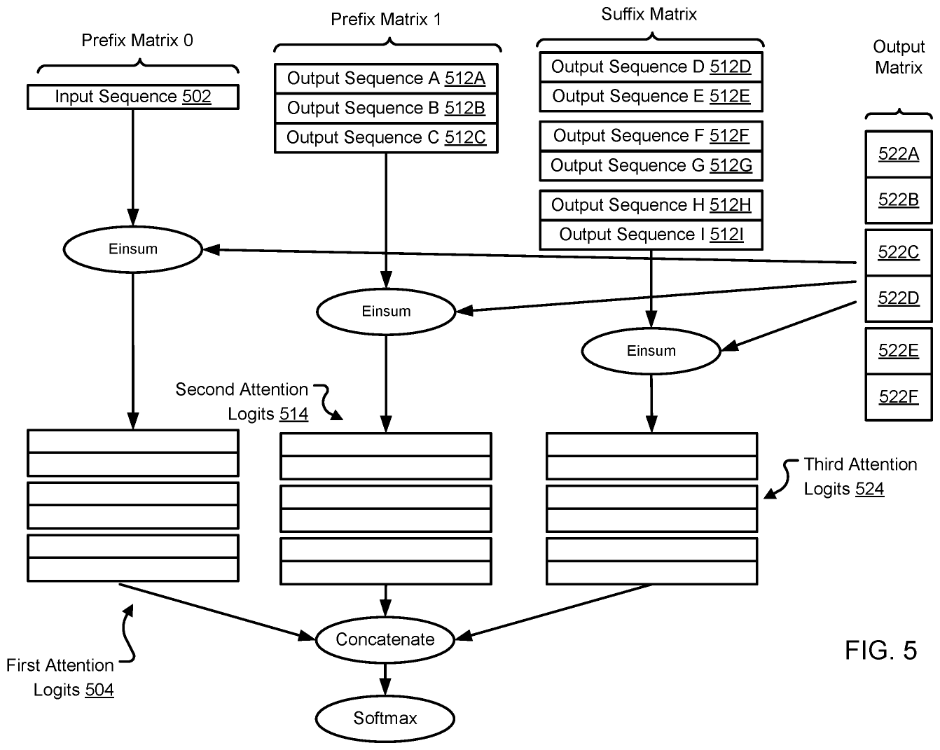

FIG. 5 is another example illustration of operations performed by an attention layer when applying multiple attention mechanisms in parallel. In FIG. 5, the system repeatedly performs the process 300 to generate a tree of output sequences, i.e., to generate a larger number of output sequences that are each a continuation of one of a smaller number of already generated output sequences.

As illustrated in FIG. 5, the system repeatedly perform the process 300 to generate, from the same input sequence 502, a first number of output sequences, e.g., output sequences A-C 512A-C. Continuing from each of the first number of output sequences, the system then generates a second number of output sequences, e.g., output sequences D-I 512D-I. Thus, the system generates the second number of output sequences conditioned on both the input sequence 502 and the first number of output sequences.

In particular, after the output sequence output sequences A-C 512A-C have been finalized, the system stores, as the prefix matrix 1 in the memory device, one copy of the embedded representations of the already generated output tokens included in these output sequence output sequences A-C 512A-C. In other words, instead of storing multiple (two, in the example of FIG. 5) copies of the embedded representations of the output tokens included in an already generated output sequence, e.g., output sequence A 512A, in order to match the number of continuation output sequences, e.g., output sequence D-E 512D-E, that are additionally being generated from the already generated output sequence, only one such copy need be stored in the memory device.

Later on, when generating the output sequences D-I 512D-I, the system broadcasts the prefix matrix 1 in-place on-demand within each attention layer to compute the attention logits 514 required for determining the weighted value matrix through the use of a compatibility (e.g., softmax) function. As described above, the weighted value matrix includes numeric values as matrix entries that represent the respective updated embedded representations of the output tokens 522A-F at the particular output positions of the multiple output sequences.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, e.g., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, e.g., inference, workloads.

Machine learning models can be implemented and deployed using a machine learning framework, e.g., a TensorFlow framework or a JAX framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method comprising:
receiving a request to generate, from an input sequence comprising a plurality of input tokens, a plurality of output sequences each comprising a respective output token at each of a plurality of output positions; and
generating, by using an auto-regressive generative neural network, the plurality of output sequences from the input sequence, wherein the auto-regressive generative neural network comprises a plurality of attention layers, and wherein the generating comprises, at an attention layer and for a particular output position of the plurality of output positions of each output sequence:
maintaining context data comprising (i) a respective embedded representation of each of the plurality of input tokens included in the input sequence and (ii) for each output sequence, a respective embedded representation of an output token at each output position that precedes the particular output position of the output sequence;
for each output sequence, receiving a respective embedded representation of the output token at the particular output position within the output sequence;
generating a first set of attention logits that includes a plurality of logit values for each of the plurality of input tokens included in the input sequence, comprising applying, using one or more queries derived from the respective embedded representation of the output token at the particular output position, a first attention mechanism over the respective embedded representation of each of the plurality of input tokens included in the input sequence;
generating a second set of attention logits that includes, for each output sequence, a logit value for the output token at each output position that precedes the particular output position, comprising applying, using the one or more queries, a second attention mechanism over the respective embedded representation of the output token at each output position that precedes the particular output position of the output sequence; and
generating, from the first and second sets of attention logits, a respective updated embedded representation of the output token at the particular output position.

2. The computer-implemented method of claim 1, wherein maintaining the respective embedded representation of each of the plurality of input tokens included in the input sequence comprises:
maintaining a prefix matrix having numeric values that represent the respective embedded representation of each of the plurality of input tokens included in the input sequence.

3. The computer-implemented method of claim 1, wherein maintaining, for each output sequence, the respective embedded representation of the output token at each output position that precedes the particular output position of the output sequence comprises:
maintaining a suffix matrix having numeric values that represent the respective embedded representation of the output token at each output position that precedes the particular output position.

4. The computer-implemented method of claim 2, wherein maintaining the prefix matrix comprises storing the prefix matrix in a memory device.

5. The computer-implemented method of claim 3, wherein the suffix matrix has more rows than the prefix matrix.

6. The computer-implemented method of claim 1, wherein the plurality of attention layers comprise a masked self-attention layer, and wherein the first and second attention mechanisms are both a masked self-attention mechanism applied by the self-attention layer.

7. The computer-implemented method of claim 2, wherein applying the first attention mechanism comprises:
computing a matrix multiplication between a key matrix generated from the prefix matrix and a query matrix representing the queries to generate a first matrix product.

8. The computer-implemented method of claim 7, wherein computing the matrix multiplication comprises broadcasting the prefix matrix along a column dimension to match a row number of the suffix matrix.

9. The computer-implemented method of claim 3, wherein applying the second attention mechanism comprises:
computing a matrix multiplication between a key matrix generated from the suffix matrix and the query matrix representing the queries to generate a second matrix product.

10. The computer-implemented method of claim 9, wherein generating the respective updated embedded representation of the output token at the particular output position comprises:
concatenating the first and second matrix products along a row dimension.

11. The computer-implemented method of claim 10, further comprising, at each attention layer and for each particular output position of the plurality of output positions of each output sequence:
processing the concatenated first and second matrix products using a compatibility function to generate a weight matrix; and
computing a matrix multiplication between the weight matrix and a value matrix generated from both the prefix matrix and the suffix matrix to generate a weighted value matrix having numeric values that represent the respective updated embedded representation of the output token at the particular output position.

12. The computer-implemented method of claim 1, wherein maintaining the context data comprises:
updating the context data to include the output token at the particular output position that has been generated based on the respective updated embedded representation of the output token.

13. One or more non-transitory computer-readable storage media storing instructions that when executed by one or more computers cause the one or more computers to perform operations comprising:
receiving a request to generate, from an input sequence comprising a plurality of input tokens, a plurality of output sequences each comprising a respective output token at each of a plurality of output positions; and
generating, by using an auto-regressive generative neural network, the plurality of output sequences from the input sequence, wherein the auto-regressive generative neural network comprises a plurality of attention layers, and wherein the generating comprises, at an attention layer and for a particular output position of the plurality of output positions of each output sequence:
maintaining context data comprising (i) a respective embedded representation of each of the plurality of input tokens included in the input sequence and (ii) for each output sequence, a respective embedded representation of an output token at each output position that precedes the particular output position of the output sequence;
for each output sequence, receiving a respective embedded representation of the output token at the particular output position within the output sequence;
generating a first set of attention logits that includes a plurality of logit values for each of the plurality of input tokens included in the input sequence, comprising applying, using one or more queries derived from the respective embedded representation of the output token at the particular output position, a first attention mechanism over the respective embedded representation of each of the plurality of input tokens included in the input sequence;
generating a second set of attention logits that includes, for each output sequence, a logit value for the output token at each output position that precedes the particular output position, comprising applying, using the one or more queries, a second attention mechanism over the respective embedded representation of the output token at each output position that precedes the particular output position of the output sequence; and
generating, from the first and second sets of attention logits, a respective updated embedded representation of the output token at the particular output position.

14. A system comprising:
one or more computers; and
one or more storage devices storing instructions that, when executed by the one or more computers, cause the one or more computers to perform operations comprising:
receiving a request to generate, from an input sequence comprising a plurality of input tokens, a plurality of output sequences each comprising a respective output token at each of a plurality of output positions; and
generating, by using an auto-regressive generative neural network, the plurality of output sequences from the input sequence, wherein the auto-regressive generative neural network comprises a plurality of attention layers, and wherein the generating comprises, at an attention layer and for a particular output position of the plurality of output positions of each output sequence:
maintaining context data comprising (i) a respective embedded representation of each of the plurality of input tokens included in the input sequence and (ii) for each output sequence, a respective embedded representation of an output token at each output position that precedes the particular output position of the output sequence;
for each output sequence, receiving a respective embedded representation of the output token at the particular output position within the output sequence;
generating a first set of attention logits that includes a plurality of logit values for each of the plurality of input tokens included in the input sequence, comprising applying, using one or more queries derived from the respective embedded representation of the output token at the particular output position, a first attention mechanism over the respective embedded representation of each of the plurality of input tokens included in the input sequence;
generating a second set of attention logits that includes, for each output sequence, a logit value for the output token at each output position that precedes the particular output position, comprising applying, using the one or more queries, a second attention mechanism over the respective embedded representation of the output token at each output position that precedes the particular output position of the output sequence; and
generating, from the first and second sets of attention logits, a respective updated embedded representation of the output token at the particular output position.

15. The system of claim 14, wherein maintaining the respective embedded representation of each of the plurality of input tokens included in the input sequence comprises:
maintaining a prefix matrix having numeric values that represent the respective embedded representation of each of the plurality of input tokens included in the input sequence.

16. The system of claim 14, wherein maintaining, for each output sequence, the respective embedded representation of the output token at each output position that precedes the particular output position of the output sequence comprises:
maintaining a suffix matrix having numeric values that represent the respective embedded representation of the output token at each output position that precedes the particular output position.

17. The system of claim 16, wherein maintaining the prefix matrix comprises storing the prefix matrix in a memory device.

18. The system of claim 17, wherein the suffix matrix has more rows than the prefix matrix.

19. The system of claim 14, wherein the plurality of attention layers comprise a masked self-attention layer, and wherein the first and second attention mechanisms are both a masked self-attention mechanism applied by the self-attention layer.

20. The system of claim 15, wherein applying the first attention mechanism comprises:
computing a matrix multiplication between a key matrix generated from the prefix matrix and a query matrix representing the queries to generate a first matrix product.
